(19) United States
(12) Patent Application Publication
(10) Pub. No.: US 2025/0144579 A1
(43) Pub. Date: May 8, 2025

(54) OXYGENATION ASSEMBLY FOR AQUACULTURE

(71) Applicant: Poseidon Ocean Systems Ltd., Campbell River (CA)

(72) Inventors: Evan LOGUE, Campbell River (CA); Mathew Stephen CLARKE, Campbell River (CA)

(73) Assignee: Poseidon Ocean Systems Ltd., Campbell River (CA)

(21) Appl. No.: 19/016,976

(22) Filed: Jan. 10, 2025

Related U.S. Application Data
(63) Continuation of application No. PCT/CA2023/050907, filed on Jul. 4, 2023.
(60) Provisional application No. 63/388,573, filed on Jul. 12, 2022.

(51) Int. Cl. B01F 23/232; A01K 63/04; B01F 23/231; B01F 23/237; B01F 35/71; B01F 101/00; C02F 1/72; C02F 103/20

(52) U.S. Cl. CPC B01F 23/232; A01K 63/042; B01F 23/23121; B01F 23/237612; B01F 35/7176; C02F 1/727; B01F 2101/305; C02F 2103/20

(57) ABSTRACT

There is provided an oxygenation assembly submersible within a body of water. The oxygenation assembly includes a mass transfer vessel configured to receive water and promote dissolving of oxygen therewithin at least in part using pressure from the body of water. The vessel is elongate and may have a fixed diameter. The oxygenation assembly includes a bubble generator downstream of the vessel and which functions as a throttling device. The bubble generator is configured to dissipate pressure within the vessel in a manner that promotes breaking up of remaining undissolved gaseous bubbles. The oxygenation assembly may include an aeration system coupled to and in this example in line with the vessel. The aeration system disperses water of elevated dissolved oxygen content throughout a larger volume of water having a lower bulk dissolved oxygen concentration.

### BACKGROUND OF THE INVENTION

### Field of the Invention

There is provided an oxygenation assembly. In particular, there is provided an oxygenation assembly for aquaculture.

### Description of the Related Art

International Patent Application Publication No. WO2021158122 to Almvik discloses a method and an arrangement of providing oxygen rich water into an upper part of a fish pen. Air bubbles are introduced into the water in the pen at a depth of between 10 and 20 meters below the water surface, at a rate that provides a lift of the water to create a continuous upwelling of water from said depth to the surface of said pen, thereby bringing oxygen rich water from said depth to the upper part of the pen. The arrangement may also comprise an oxygen diffusor arranged above the air bubble unit.

U.S. Pat. No. 4,749,493 to Hicks discloses a method and apparatus for oxygenating water in an aquaculture system without adding nitrogen or other possibly harmful gases. A columnar housing floats in the aquaculture pond on a float ring with a submersible pump immersed in the pond. The pump draws in water and pumps it to the top of an oxygenation chamber which is packed with a surface expansion medium. The oxygenation chamber is filled with oxygen which is transferred to the water falling through the chamber. The oxygenated water is returned to the pond through outlet ports at the bottom of the oxygenation chamber. A cover on the column can be removed at times to allow infiltration of air for aeration of the water.

U.S. Pat. No. 5,938,983 to Sheaffer discloses a bubble diffusion aerator mounted onto a “pot” aerator, for oxygenating a body of water. The bubble diffusion aerator comprises spiral coils of perforated flexible tubing mounted onto a flat frame, with a single air feed line connected to the tubing at a point equidistant from the tubing ends for uniform air pressure. The frame has openings to provide a continuous flow of oxygen-deficient water across the coiled tubing. The “pot” aerator has a vertical pipe with an air feed line, with the vertical pipe mounted on a base. The diffusion aerator is mounted to the vertical pipe of the “pot” aerator at a position up off the water body bottom, minimizing air hole clogging and bottom sediment disturbance. Each aerator has a separate air feed line connected to an air compressor on shore. The aerators can be operated independently, running only the diffusion aerator for air/water transfer, running only the pot aerator to create water movement, or running both to maximize the benefits of each aerator. A vertical pipe, without an aerator feed line, may be provided to support the diffuser aerator at an elevated position where a “pot” aerator is not required.

United States Patent Application Publication No. 2001/0045673 A1 to Ogston et al. discloses a method and apparatus for dissolving oxygen in water. The method comprises introducing a supply of oxygen containing gas into a pressurized stream of water to produce a two phase flow and reducing the gas bubble size in the flow allowing time for mass transfer between the bubbles and the water.

Chinese Patent Reference No. 109516578 A to Yang discloses aeration oxygen charging methods and devices involving fining air bubbles. The method includes mixing a water inlet along vertical pipeline downlink with gases such as air or oxygen on the water surface. The gas-liquid mixture of formation continues traveling downwardly successively along pipeline through the suspended bubble group generator and bubble refining device under the water surface, then by an outlet valve in the horizontal direction at the bottom to be discharged, finally exporting bubbles diagonally on a path to a water body carry out aeration. The method may increase a gas liquid interfacial area, with bubble diameter becoming smaller, bubble residence time substantially extending, and with an increasing dissolved oxygen efficiency and oxygen utilization rate. This may realize a high efficient aeration oxygenation to the water body. Compared with conventional microporous aeration, the microbubble aeration that whole process is generated using a large diameter pipeline which may thoroughly solve traditional aeration head dirt and blocks up maintenance problems.

U.S. Pat. No. 4,749,493 to Hicks discloses a method and apparatus for oxygenating water in an aquaculture system without adding nitrogen or other possibly harmful gases. A columnar housing floats in the aquaculture pond on a float ring with a submersible pump immersed in the pond. The pump draws in water and pumps it to the top of an oxygenation chamber which is packed with a surface expansion medium. The oxygenation chamber is filled with oxygen which is transferred to the water falling through the chamber. The oxygenated water is returned to the pond through outlet ports at the bottom of the oxygenation chamber. A cover on the column can be removed at times to allow infiltration of air for aeration of the water.

Chinese Patent Reference No. 105384264 to Chen discloses a deepwater lake water restoring method through bubble plume dispersion oxygenation. In a water stratification period, a plume oxygenation jetting device is arranged at the bottom of a lake, an air source of the plume oxygenation jetting device is pure oxygen, bubbles jetted from the plume oxygenation jetting device and introduced water form an air-water mixture. The air-water mixture ascends to the maximum altitude before thermal stratification while the bubbles are continuously dissolved and disappear, sinking plume is formed due to density difference, oxygen-rich water diffuses all around and enters a distant water environment after the plume sinks to the balance depth, the hypolimnion is directly oxygenated, and the ascending velocity of the air-water mixture is 0.12-0.17 m/s. The deepwater lake water restoring method through the bubble plume dispersion oxygenation may be strong in pertinence; ascending bubbles are rapidly dissolved, the oxygen transfer efficiency is high, the oxygenation effect is good, and the operation difficulty and construction difficulty are greatly simplified. The deepwater lake water restoring method through the bubble plume dispersion oxygenation may have the characteristics of no disturbance on the thermal stratification, no damage of a lakebed cold water fish growth environment, high feasibility, low implementation risk and good water restoring effect.

The above-described prior art may suffer a number of disadvantages.

### BRIEF SUMMARY OF INVENTION

There is provided, and it is an object to provide, an improved oxygenation assembly for aquaculture disclosed herein.

The oxygenation assembly as herein described may be referred to as a rapidly deployable/retrievable assembly that provides a means to efficiently dissolve gaseous oxygen into water, raise the dissolved oxygen (DO) concentration of the water thereby, and disperse the highly oxygenated water throughout a larger water volume with a lower bulk DO concentration. This process is carried out in two major steps: 1) generation of a high-DO pumped water stream available as a point-source; and 2) dispersion of that water stream point-source into an aeration bubble plume for dispersal.

There is accordingly provided an oxygenation assembly for aquaculture according to one aspect. The oxygenation assembly includes a mass transfer vessel configured to be submerged, receive water when so submerged and promote dissolving of oxygen therewithin when so submerged. The vessel has an inlet, an outlet spaced-apart from the inlet thereof, and a cross-sectional area that extends between the inlet and the outlet thereof. The cross-sectional area of the vessel is substantially constant.

There is also provided an oxygenation assembly according to another aspect. The oxygenation assembly includes a mass transfer vessel configured to receive water and promote dissolving of oxygen therewithin. The oxygenation assembly includes a bubble generator downstream of the vessel.

There is further provided an oxygenation assembly according to an additional aspect. The oxygenation assembly includes a submersible, pressurized mass transfer vessel to which water is pumped and oxygen is injected. The oxygenation assembly includes an aeration system coupled to the vessel.

There is also provided, in combination, a device for producing highly oxygenated water and an aeration system coupled to and in line with the device.

There is additionally provided an oxygenation assembly according to a further aspect. The oxygenation assembly includes an oxygen-water mass transfer vessel. The oxygenation assembly includes a pump in fluid communication with an inlet of the vessel. The oxygenation assembly includes an aeration system in fluid communication with an outlet of the vessel.

There is further provided an oxygenation assembly according to yet an additional aspect. The oxygenation assembly includes an oxygen-water mass transfer vessel configured to receive oxygen injected therein and water therethrough. The oxygenation assembly includes an aeration system operatively connected to and positioned above the vessel.

In each of the above instances of an aeration system, an upwelling system may in the alternative be used which is configured to create an upwelling using compressed or pressurized gas.

There is yet further provided an oxygenation assembly according to another aspect. The oxygenation assembly includes an oxygen-water mass transfer vessel. The oxygenation assembly includes a pump configured to direct water through the vessel. The pump aligns with the longitudinal axis of the vessel and/or is positioned below the vessel.

There is also provided an oxygenation assembly according to an additional aspect. The oxygenation assembly includes an oxygen-water mass transfer vessel. The oxygenation assembly includes a pump. The oxygenation assembly includes a first conduit which couples an output of the pump to an inlet of the vessel. The oxygenation assembly includes a second conduit. The second conduit has a proximal end operatively connected to an outlet of the vessel. The second conduit has a distal end spaced-apart upwards from the inlet of the vessel. The conduits extend at least in part substantially parallel to the longitudinal axis of the vessel.

There is yet also provided an oxygenation assembly according to yet another aspect. The oxygenation assembly includes an oxygen-water mass transfer vessel configured to receive oxygen injected therein and water therethrough. The oxygenation assembly includes an air diffuser operatively coupled to the vessel. The air diffuser is annular and/or coil shaped.

There is also provided an oxygenation assembly comprising according to another aspect. The assembly includes a mass transfer vessel configured to receive water and promote dissolving of oxygen therewithin. The assembly includes a bubble generator downstream of the vessel. The bubble generator is configured to increase pressure within the vessel when the water passes therethrough.

There is further provided an oxygenation assembly according to a further aspect. The assembly includes a mass transfer vessel configured to receive water and promote dissolving of oxygen therewithin. The assembly includes a bubble generator downstream of the mass transfer vessel. The bubble generator aligns with the longitudinal axis of the vessel.

There is yet also provided an oxygenation assembly according to an additional aspect. The assembly includes a mass transfer vessel configured to receive water and promote dissolving of oxygen therewithin. The assembly includes a bubble generator downstream of the mass transfer vessel. The bubble generator comprises a throttling device.

There is yet further provided an oxygenation assembly according to an additional aspect. The assembly includes a mass transfer vessel configured to receive water and promote dissolving of oxygen therewithin. The assembly includes a bubble generator downstream of the mass transfer vessel. The bubble generator is one of a venturi tube, an orifice generator and a swirl generator.

There is additionally provided an oxygenation assembly according to yet a further aspect. The assembly includes a submersible, pressurized mass transfer vessel to which water is pumped and oxygen injected. The assembly includes a system for creating an upwelling using compressed or pressurized gas. The system couples to the mass transfer vessel.

There is also provided an oxygenation assembly according to another aspect. The assembly includes an oxygen-water mass transfer vessel. The assembly includes a pump in fluid communication with an inlet of the oxygen-water mass transfer vessel. The assembly includes a system for creating an upwelling using compressed or pressurized gas. The system is in fluid communication with an outlet of the oxygen-water mass transfer vessel. The assembly includes one or more a temperature, pressure or depth sensor/gauge via which a target depth at or below which to submerge the vessel is determined.

There is further provided an oxygenation assembly according to yet another aspect. The assembly includes a mass transfer vessel configured to receive water and promote dissolving of oxygen therewithin. The assembly includes one or more of a temperature, pressure or depth sensor/gauge via which a target depth at or below which to submerge the vessel is determined. The assembly may optionally include a bubble generator downstream of the mass transfer vessel.

There is yet also provided an oxygenation assembly for aquaculture according to an additional aspect. The oxygenation assembly includes a mass transfer vessel with an inlet and outlet via which water is pumpable therethrough. The mass transfer vessel includes a port between the inlet and outlet thereof and via which gaseous oxygen is injectable. The mass transfer vessel is fully submergible into a body of water so as to pressurize said water therewithin, with the mass transfer vessel using at least in part pressure from the body of water to promote dissolving of the gaseous oxygen into said water.

There is further provided a method of dissolving oxygen into water according to one aspect. The method includes submerging a mass transfer vessel into a body of water. The method includes injecting oxygen into the vessel. The method includes outputting said water of higher dissolved oxygen content.

There is additionally provided a method of oxygenating water for aquaculture according to one aspect. The method includes generating within a body of water a pumped stream water of high dissolved oxygen as a point-source. The method includes directing said pumped stream of water of high dissolved oxygen into an aeration bubble plume for dispersal.

There is further provided a method of oxygenating water for aquaculture according to another aspect. The method includes submerging an oxygenation assembly into a body of water. The method includes pumping water through the oxygenation assembly so submerged and dissolving gaseous oxygen at depth into said water so pumped so as to raise the dissolved oxygen (DO) concentration of the water. The method includes dispersing the water so oxygenated throughout a larger water volume with a lower bulk DO concentration.

Further aspects and example embodiments are illustrated in the accompanying drawings and/or described in the following description.

### BRIEF DESCRIPTION OF DRAWINGS

The accompanying drawings illustrate non-limiting example embodiments of the invention.

FIG. 1 is a front elevation view of an oxygenation assembly according to one aspect;

FIG. 2 is a front, top perspective view thereof;

FIG. 3 is a schematic view thereof, with the oxygenation assembly including a bubble generator according to one variant;

FIG. 4 is a schematic view of a bubble generator for the oxygenation assembly of FIG. 3, with the bubble generator being according to another variant; and

FIG. 5 is a schematic view of a bubble generator for the oxygenation assembly of FIG. 3, with the bubble generator being according to a further variant.

### DESCRIPTION OF THE PREFERRED EMBODIMENTS

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

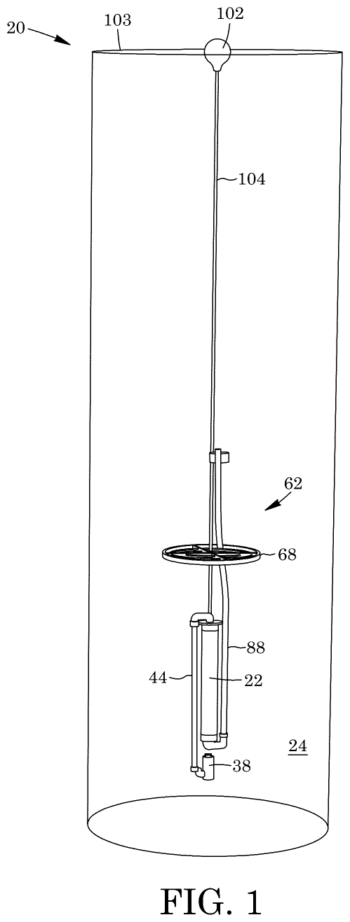

Referring to the drawings and first to FIG. 1, there is shown oxygenation assembly 20. The oxygenation assembly may be referred to as an oxygenation assembly or as a device for producing highly oxygenated water. Oxygenation assembly 20 may additionally or alternatively be referred to as a submersible system for oxygen infusion and distribution of oxygenated water. The oxygenation assembly is configured to be portable. Oxygenation assembly 20 is configured to be selectively deployable or retrievable.

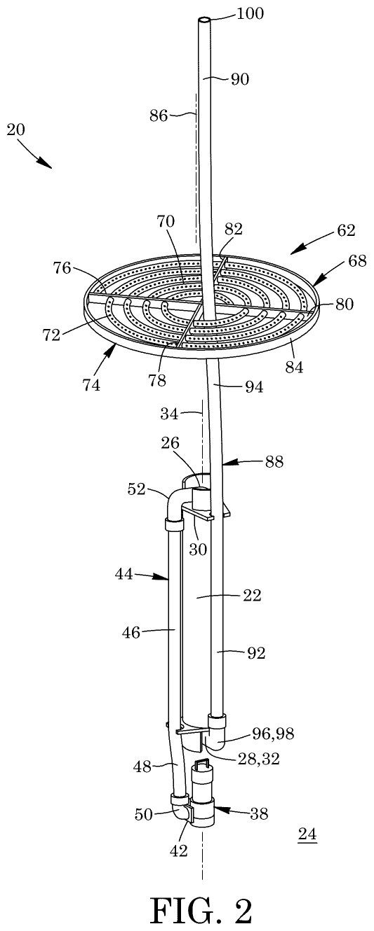

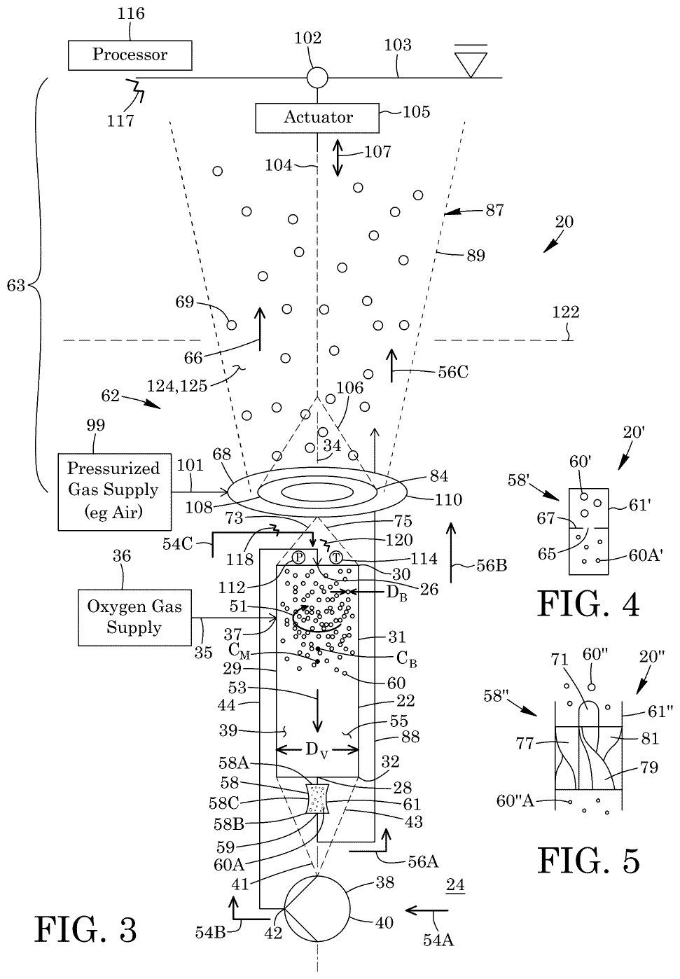

The oxygenation assembly includes a mass transfer vessel, in this example an oxygen-water mass transfer vessel 22. The vessel is configured to receive water 24 and promote dissolving of oxygen therewithin. As seen in FIG. 3, vessel 22 has a first or water inlet 26 and an outlet 28 spaced-apart from the water inlet thereof. The vessel is elongate with a top 30 adjacent the water inlet thereof in this example and a bottom 32 spaced-apart from the top thereof. The bottom of vessel is adjacent outlet 28 of the vessel in this example. As seen in FIG. 2, vessel 22 has a longitudinal axis 34 extending between top 30 and bottom 32 thereof. The longitudinal axis of the vessel extends at substantially vertically in this example when oxygenation assembly 20 is in use; however, this is not strictly required and the vessel may extend partially in the vertical direction in other embodiments. Vessel 22 is configured to direct water downwards therethrough in this example, as shown by arrow of numeral 53.

The vessel is tubular in this example and may be made from a conduit or pipe; however, the latter is not strictly required. Vessel 22 is cylindrical in outer shape in this non-limiting embodiment; however, this is not strictly required. The vessel has a diameter D_{V} seen in FIG. 3 and a corresponding cross-sectional area which extend between water inlet 26 and outlet 28 thereof. The diameter and cross-sectional area of the vessel in this non-limiting embodiment are substantially constant at least between the water inlet and outlet thereof in this example, in this case being constant from top 30 to bottom 32 of the vessel.

Vessel 22 is configured to be selectively submersible in a body of water 24. Still referring to FIG. 3, oxygenation assembly 20 has a center of buoyancy C_{B} that generally aligns with longitudinal axis 34 of the vessel in this example. Vessel 22 has a center of gravity or mass C_{M} that in this example is generally centrally positioned between water inlet 26 and outlet 28 thereof; however, this is not strictly required. The center of mass of the vessel aligns with longitudinal axis 34 thereof in this example. Oxygenation assembly 20 is configured such that center of buoyancy C_{B} generally corresponds to and/or is positioned above center of mass C_{M} of the vessel in this example.

Vessel 22 receives water therewithin, and is also configured to receive oxygen injected therewithin as shown by numeral 35 via an oxygen gas supply 36. Oxygenation assembly 20 may include an oxygen injector to direct oxygen into the vessel. However, this is not strictly required and pressurized oxygen may be supplied and injected into vessel 22 through other means in other examples, such as via a pressurized oxygen tank or an oxygen generator/compressor coupled to the vessel via pressurized hosing (not shown) for example. The pressurized oxygen tank, oxygen generator/compressor and related hosing may be part of oxygenation assembly 20. The oxygen injected into vessel 22 may but need not necessarily comprise high purity oxygen gas. The term “gaseous oxygen” is intended to encompass injected gas comprising oxygen anywhere in the range of equal to or greater than that found in air, to high purity oxygen gas.

Gaseous oxygen 36 is injected (as shown by arrow 35) into vessel 22 between water inlet 26 and outlet 28 of the vessel in this non-limiting embodiment. The vessel is configured to receive gaseous oxygen in a tangential direction in this example, so as to promote movement of oxygen bubbles in a direction tangential relative to longitudinal axis 34 of the vessel and/or flow of water therethrough as shown by arrow 51. Capturing or absorbing bubbles of oxygen above a threshold diameter within water 55 enclosed by vessel 22 may be a function of the diameter size of the vessel for a given water throughput. Diameter D_{V} of the vessel may thus be selected based on a given water throughput to capture or absorb bubbles of oxygen for a given said threshold diameter or within a predetermined bubble diameter D_{B} range.

Oxygenation assembly 20 includes a pump, in this example a submersible water pump 38. The pump is in this example positioned below vessel 22. Pump 38 in this non-limiting embodiment is positioned adjacent the vessel, in this case being adjacent outlet 28 and bottom 32 of the vessel. The pump in this example aligns with longitudinal axis 34 of vessel 22. Pump 38 has an inlet 40 and an outlet 42, which may be referred to as the input and output of the pump, respectively. The inlet of the pump pulls from the free water 54A adjacent and/or below the pump. As seen in FIG. 2, outlet 42 of the pump is positioned below vessel 22 in this example; however, this is not strictly required. Referring to FIG. 3, pump 38 may couple to vessel 22 in part via one or more flexible lines or tethers 41 and 43 that couple to and extend downwards from sides 29 and 31 and bottom 32 of the vessel. However, this is not strictly required and the pump may couple to the vessel through other means or methods in other embodiments. Pump 38 is thus suspended from vessel 22, being positioned adjacent to and/or being spaced downwardly from bottom 32 of the vessel.

Outlet 42 of pump 38 is in fluid communication with water inlet 26 of the vessel. As seen in FIG. 2, oxygenation assembly 20 includes a first conduit, in this example an input conduit 44. Outlet 42 of pump 38 and water inlet 26 of vessel 22 are in fluid communication in this example via the input conduit. The pump in this example also couples to and may be suspended from the vessel via input conduit 44; however, the latter is not strictly required. The input conduit extends in this example adjacent to vessel 22. Input conduit 44 in this non-limiting embodiment comprises piping in the form of: a first elongate pipe 46; a second elongate pipe 48 coupled to the first elongate pipe and which is bent at least in part; and a pair of spaced-apart third and fourth angle pipes 50 and 52 which couple to outlet 42 of pump 38 and water inlet 26 of vessel 22, respectively, with the first and second pipes extending therebetween. Input conduit 44 may thus be referred to as comprising one or more pipe elements. However, this is not strictly required and input conduit 44 may take other forms in other examples. First and second pipes 46 and 48 of the input conduit extend in this example substantially parallel to longitudinal axis 34 of vessel 22; however, this is not strictly required. The first and second pipes of input conduit 44 in this case extend substantially vertically when oxygenation assembly 20 is in use; however, this too is not strictly required. Second pipe 48 is shaped to position pump 38 below vessel 22 so as to align the pump with longitudinal axis 34 of the vessel in this non-limiting embodiment.

Referring to FIG. 3, pump 38 is configured to direct or output water of lower oxygen content, as shown by arrows 54A/54B/54C, into vessel 22. Outlet 42 of the pump is routed to top 30 of vessel 22 in this example, where the pumped water 54B/54C enters via water inlet 26 and is directed downwards into a mass transfer zone 39 within the vessel. The vessel is thus configured to receive water 24 having a first concentration of dissolved oxygen (DO). Simultaneously, gaseous oxygen 36 is injected (as shown by arrow 35) into mass transfer zone 39 within vessel 22. The gaseous oxygen is dissolved into water 55 enclosed by the vessel. Vessel 22, with its downwardly directed water passing therethrough, is configured to inhibit oxygen gas bubbles 60 from escaping upwards. The vessel so configured may thus promote a large swarm of circulating oxygen bubbles (as shown by arrow of numeral 51) entrained in a relatively slow downward flow 53 of water 55. The oxygen is injected into vessel 22 in a direction perpendicular to and/or tangential to the downward flow through of water the vessel in this example.

As seen in FIG. 3, vessel 22 has a second or oxygen inlet 37. The oxygen inlet is positioned between water inlet 26 and outlet 28 of the vessel in this example. Oxygen inlet 37 of vessel 22 receives gaseous oxygen 35/36. The oxygen inlet of the vessel is configured and/or sized to promote breaking up of gas bubbles towards a desired diameter, which may lead to the stability of mass transfer zone 39. A majority of the injected oxygen 35/36 may become entrained in larger-bubble form, becoming a part of the mass transfer zone until the gaseous oxygen is dissolved within water 55. A relatively small amount of the injected gaseous oxygen may be broken into fine bubbles, which may be carried with water 55 in the downward flow 53 with no appreciable rising effect.

Vessel 22 is configured to output water that has a second concentration of dissolved oxygen (DO), as shown by arrows 56A/56B/56C. The water of the second concentration of DO has a higher DO content compared to that of the water of the first concentration of DO entering the vessel (shown by arrows 54A/54B/54C).

Still referring to FIG. 3, oxygenation assembly 20 includes a bubble generator 58. The bubble generator in this non-limiting embodiment comprises a conduit, in this case in the form of a venturi tube 61; however, this is not strictly required. The venturi tube includes two spaced-apart, enlarged end portions 58A and 58B and an appropriately sized constriction 58C extending therebetween. The constriction of venturi tube 61 has a cross-sectional area which is smaller than that of the end portions of the venturi tube. Constriction 58C is sized to promote breaking of oxygen gas bubbles 60 to oxygen gas bubbles of smaller sizes 60A so as to promote dissolving of oxygen in water 55/56A. Bubble generator 58 is thus configured to reduce diameter D_{B} of bubbles passing therethrough.

Alternatively and referring to FIG. 4, bubble generator 58′ of oxygenation assembly 20′ may be in the form of an orifice generator with at least one appropriately sized orifice 65 to promote breaking of oxygen gas bubbles 60′ to oxygen gas bubbles of smaller sizes 60′A. The bubble/orifice generator may include an orifice plate 67 spanning conduit 61′ and through which the orifice extends; however, this is not strictly required.

As a further alternative and referring to FIG. 5, bubble generator 58″ of oxygenation assembly 20″ may be in the form of a swirl generator with a rotor 71 that is rotatable relative to conduit 61″. One or more curved members, in this example rotator blades 77, 79 and 81 couple to and radially outwardly extend from the rotor. The blades and rotor are shaped to promote breaking up of oxygen gas bubbles 60″ into oxygen gas bubbles of smaller sizes 60″A. One non-limiting example of a swirl generator is described in “SMALL BUBBLES GENERATION WITH SWIRL BUBBLERS FOR SNS TARGET”, authored by C. Barbier, E. Dominguez-Ontiveros and R. Sangrey, having a paper number of FEDSM2018-83077, V003T20A001, available via the following link: https://doi.org/10.1115/FEDSM2018-83077, which may have been presented at 5th Joint US-European Fluids Engineering Summer Conference, Jul. 15-20, 2018, Montreal, Quebec, Canada, and the disclosure of which is incorporated herein by reference.

Bubble generator 58/58′/58″ seen in FIGS. 3 to 5 is coupled to and in fluid communication with vessel 22 seen in FIG. 3. Still referring to FIG. 3, the bubble generator is in this example downstream of the vessel, in this case being in fluid communication with outlet 28 of the vessel. The effluent flow of vessel 22, as shown by downward flow 53, is directed through bubble generator 58, where remaining oxygen gas bubbles 60 are broken to oxygen gas bubbles of smaller sizes 60A and dispersed in within water 55/56A/56B/56C. The bubble generator aligns with longitudinal axis 34 of vessel 22 in this example. Bubble generator 58/58′/58″ seen in FIGS. 3 to 5 is adjacent outlet 28 and bottom 32 of the vessel seen in FIG. 3 in this example.

The bubble generator functions in part as a throttling device, with the bubble generator in this example functioning to set a flow rate of pump 38. Bubble generator 58/58′/58″ is configured in part to increase pressure within vessel 22 when water 54A/54B/54C/56A/56B/56C passes therethrough, with dissolving of the oxygen within water enclosed by the vessel being further promoted thereby. The bubble generator in this example is configured to create a backpressure that increases pressure within vessel 22 when the water passes therethrough. Bubble generator 58/58′/58″ is configured to contain the pump pressure head within the vessel.

The bubble generator is configured in part to dissipate pressure within vessel 22 caused by pump 38 in a manner that promotes breaking up of remaining undissolved oxygen gas bubbles 60. Bubble generator 58/58′/58″ is therefore configured to promote dissolving of bubbles passing therethrough, continuing to process any free gas into smaller bubbles, and improving a dissolution rate of the free gas thereby. Bubble generator 58/58′/58″ is thus configured to further promote dissolving of the oxygen within water 54A/54B/54C/56A/56B/56C.

Oxygenation assembly 20 includes a system for creating an upwelling using compressed or pressurized gas, in this example an aeration system 62. The aeration system is operatively coupled to vessel 22. Aeration system 62 in this example is positioned above the vessel. The aeration system in this non-limiting embodiment is in line with vessel 22, in this case aligning with longitudinal axis 34 of the vessel. Pump 38 is positioned below aeration system 62. The aeration system includes a diffuser, in this example an air diffuser 68.

Aeration system 62 may couple to vessel 22 in part via one or more flexible lines or tethers 73 and 75 that couple to and extend downwards from the diffuser, with the vessel thus being suspended from diffuser 68. However, this is not strictly required and the vessel may couple to the aeration system in other manners in other embodiments. As seen in FIG. 2, diffuser 68 is annular and/or coil-shaped in this example; however, here too this is not strictly required. The diffuser in this non-limiting embodiment comprises one or more conduits that are annular at least in part. Diffuser 68 in this example is in the form of a planar coil 70 with a plurality of circumferentially spaced-apart apertures 72 extending therein.

The coil is held in place via a mount 74 in this example. The following is a non-limiting embodiment which achieves this functionality. Mount 74 in this example includes a plurality of radially-extending elongate frame members 76, 78, 80 and 82 which are coupled together and form a cross or X-shape. The mount includes an outer annular frame member 84 which extends about and couples to peripheral distal end portions 83 of the elongate frame members in this non-limiting embodiment. Coil 70 is shaped to couple to elongate frame members: in this non-limiting embodiment, each elongate frame member has a plurality of longitudinally spaced-apart apertures 91, 93, 95 and 97 extending through and via which portions of the coil are received, respectively. The planar coil is thus supported by elongate frame members 76, 78, 80 and 82. Coil 70 is also enclosed and protected at least in part by annular frame member 84. However, this is not strictly required. Diffuser 68 and/or the coil thereof may be referred to as an aeration diffuser ring. The diffuser extends about an axis 86 parallel to and/or coaxial with longitudinal axis 34 of vessel 22 in this example.

Referring to FIG. 3 and as part of aeration system 62, pressurized or compressed gas in this example in the form of air supply 99 is selectively injected into coil 70 of diffuser 68 as shown by arrow 101. The aeration system may in this example include an air injector to this end. However, the latter is not strictly required and pressurized air may be supplied to through other means in other examples, such as via a pressurized air tank or air compressor coupled to diffuser 68 via pressurized hosing for example. The pressurized air tank or air compressor may also be part of aeration system 62. Pressurized or compressed gas other than air may be used in other embodiments, with system 62 in such instances being referred to as a system configured to create an upwelling using compressed or pressurized gas.

Aeration system 62 is configured to selectively create an upwelling 63. The aeration system creates the upwelling in this non-limiting embodiment by injecting air 99/101 through coil 70 of diffuser 68 and outwards of apertures 72, with an array of air bubbles 69 being formed thereby. The buoyancy (density differential) causes the bubbles to rise upwards towards the surface. Some of the air bubbles may disperse outwards in part as they rise. Diffuser 68 so shaped, with the air bubbles extending outwards therefrom, is configured to form a bubble plume 87. The bubble plume is generally in an inverse frustoconical shape in this example, with an outwardly flared aeration plume boundary 89 extending upwards and radially outwards from annular frame member 84 of diffuser 68. Air bubbles 69 are thus diffused with diffuser 68 being configured to receive input air injection 99/101 to create bubble plume 87, exploiting this process to create upwelling 63 of water. This process may function to move a large volume of free water 124 vertically for a relatively small consumption of compressed air. The aeration system is thus configured to direct upwards 66 water 56C of an elevated dissolved oxygen content outputted from vessel 22.

As seen in FIG. 3, oxygenation assembly 20 includes a second conduit, in this example an output conduit 88. Vessel 22 and aeration system 62 are in fluid communication via the output conduit. Output conduit 88 is in this example adjacent in part to the vessel. The output conduit in this non-limiting embodiment comprises piping in the form of: a first and second elongate pipes 90 and 92, a third pipe 94 extending between the first and second elongate pipes and which is bent at least in part; and a fourth angled pipe 96 which couples to outlet 59 of bubble generator 58 and which thus operatively couples together the second elongate pipe and outlet 28 of vessel 22. Output conduit 88 may be referred to as one or more pipe elements or may be referred to as an effluent hose, for example. However, this is not strictly required and the output conduit may take other forms in other examples.

First and second pipes 90 and 92 of output conduit 88 in this non-limiting embodiment extend substantially parallel to longitudinal axis 34 of vessel 22, as well as extending generally parallel to third pipe 94. The first, second and third pipes of the output conduit in this case extend substantially vertically when oxygenation assembly 20 is in use; however, this is not strictly required. Referring to FIG. 3, the effluent flow of water 56A/56B/56C passing through bubble generator 58 thus travels vertically through output conduit 88 and parallel with vessel 22 in this example. The output conduit is centrally positioned relative to diffuser 68 in this example. As seen in FIG. 2, third pipe 94 is bent in part to align first pipe 90 with vessel 22 and in this example longitudinal axis 34 of the vessel; however, this is not strictly required.

Output conduit 88 has a first, proximal or lower end 98, corresponding to and aligning with fourth pipe 96, which thus operatively couples to outlet 28 of vessel 22. The output conduit has a second, distal or upper end 100 that is open and spaced-apart from the lower end thereof. The upper end of output conduit 88 aligns with and/or is spaced-apart upwards from coil 70 of diffuser 68 in this example. However, this is not strictly required and the upper end of the conduit may be positioned below the diffuser so long as the diffuser functions to draw oxygen-enriched water outputted from the upper end of the output conduit upwards. Output conduit 88 may thus be said to extend from outlet 28 of vessel 22 towards and/or upwards from aeration system 62. Referring to FIG. 3, oxygenation assembly 20 is thus configured to output water 56C with elevated levels of dissolved oxygen from the vessel towards the aeration system, in this example via output conduit 88. Aeration system 62 is therefore in fluid communication with outlet 28 of vessel 22. The water stream of high dissolved oxygen content (as shown by numeral 56C) is thus released into upwelling 63 of water 124 created by bubble plume 89. This creates a zone 125 where water 56A/56B/56C of high dissolved oxygen content mixes into upward flow of water 124 of low dissolved oxygen content, effectively distributing the water of high dissolved oxygen content over/within/along the path travelled by the upwelling and bubble plume 87.

As seen in FIG. 1, oxygenation assembly 20 includes a float member 102. The float member in non-limiting examples may comprise a buoy, be part of a floating aquaculture component such as a floatation collar and/or comprise another similar floatation device. Vessel 22 operatively couples to float member 102. The following is a non-limiting embodiment which achieves this functionality.

The vessel extends downwards from and is suspendable within body of water 24 via the float member. Float member 102 aligns with diffuser 68, vessel 22 and pump 38 in this non-limiting embodiment, in this case aligning parallel to and/or coaxial with longitudinal axis 34 of the vessel. Referring to FIG. 3, the float member in this example couples to the diffuser via one or more flexible lines, in this case a rigging line 104. However, with a Y-shaped end portion 106 couples to spaced-apart peripheral portions 108 and 110 of the diffuser. Diffuser 68 is thus suspended from the rigging line, to which may be selectively attached float member 102 at the surface. However, this is not strictly required and float member 102 may couple to aeration equipment 62 and/or vessel 22 via other mechanisms or means in other embodiments. Rigging line 104 is sized to enable diffuser 68, vessel 22 and/or pump 38 of oxygenation assembly 20 as herein described to be suspendable at a great depth below water level 103. In one non-limiting embodiment, the lower/deeper the vessel is positioned vertically within body of water 24, the greater the pressure at which the vessel is subjected, the colder the intake water and the more efficient/effective the oxygen dissolution process may be as discussed in further detail below.

However, the extent to which the vessel is positioned vertically within body of water 24 may also be quantified, controlled automatically and/or selectively adjusted in one non-limiting embodiment. The following is a non-limiting example that achieves this functionality.

Oxygenation assembly 20 may include an actuator 105 configured to selectively adjust the vertical extent to which vessel 22 is positioned within body of water 24 as shown by arrows 107; however this is not strictly required. For example, in other embodiments the effective length of rigging line 104 and thus the extent to which the vessel extends downwards into the body of water, may be adjusted manually without an actuator being required.

As seen in FIG. 3, oxygenation assembly 20 in this non-limiting embodiment includes a pressure sensor 112; however, this is not strictly required a water depth sensor may be used in other non-limiting embodiments, for example. The pressure sensor is operatively coupled to vessel 22 and emits a signal 118 indicative of the pressure at which the vessel is subjected by body of water 24.

Still referring to FIG. 3, oxygenation assembly 20 in this non-limiting embodiment includes a temperature sensor 114. The temperature sensor is operatively coupled to vessel 22 and emits a signal 120 indicative of the temperature of body of water 24 at the depth to which the vessel 22 is positioned.

Oxygenation assembly 20 includes in this example a processor 116 in communication with sensors 112 and 114 and actuator 105 as shown by signals 117, 118 and 120. The processor in this non-limiting embodiment is configured to receive signals from one or more of the sensors and selectively adjust vertical positioning of vessel 22 within body of water 24 via actuator 105. For example, processor 116 may be configured to cause the vessel to continue to be lowered until the processor determines via pressure sensor 112 that the pressure of the body of water and/or the pressure at/adjacent the exterior of the vessel is equal to or less than a predetermined pressure threshold. This may provide an indication of the depth at which the vessel is positioned. Oxygenation assembly 20 may thus be configured via processor 116, pressure sensor 112 and/or actuator 105, to selectively submerge the vessel to or below a predetermined water pressure and/or depth body of water 24 according to one non-limiting embodiment.

In addition or alternatively, processor 116 may be configured to cause the vessel to continue to be lowered until the processor determines via temperature sensor 114 that the temperature of the body of water and/or the temperature at/adjacent the exterior of the vessel is equal to or less than a predetermined temperature threshold. This may enable vessel 22 to be lowered below a thermocline 122. Oxygenation assembly 20 may thus be configured via processor 116, temperature sensor 114 and/or actuator 105 to submerge the vessel below the thermocline of body of water 24. The processor may thus make determinations regarding the extent to which the oxygenation assembly should be lowered based on data received from sensors 112 and 114 and/or other sensors. Pressure sensors, temperature sensors and processors, including their various parts and functionings, are known per se and pressure sensor 112, temperature sensor 114 and processor 116 will accordingly not be described in further detail.

Referring to FIG. 3, there is accordingly provided a method of dissolving oxygen 35/36 into water 54A/54B/54C/56A/56B/56C. The method includes submerging vessel 22 into body of water 24. The method includes submerging the vessel so as to pressurize water 55 therewithin.

The method may in this example include submerging vessel 22 within body of water 24 to or below a depth at which a pressure of the body of water is equal to or less than a predetermined pressure threshold as determined by pressure sensor 112, pressure gauge and/or depth sensor/gauge. The method may in this example include submerging the vessel below thermocline 122 of body of water 24. The method in this example may include submerging vessel 22 within the body of water until a temperature of the body of water is equal to or less than a predetermined temperature threshold as determined by temperature sensor 114 and/or depth sensor/gauge.

The method in this example includes pumping water 54A from below vessel 22 therewithin. The method in this example includes providing pump 38 to direct water through the vessel, including positioning inlet 40 of the pump below the vessel.

The method includes injecting oxygen 35/36 into vessel 22 so pressurized/submerged, with dissolving of the oxygen into the water 55 being promoted thereby. The method includes using at least in part pressure from body of water 24 to promote dissolving of oxygen within the water enclosed by and/or passing through the vessel. The method in this example includes using colder water 54A from body of water 24 to promote dissolving of the oxygen therewithin.

The method in this example includes positioning of bubble generator 58/58′/58″ seen in FIGS. 3 to 5 downstream and/or in fluid communication with outlet 28 of vessel 22. Referring back to FIG. 3, the method may include aligning the bubble generator with longitudinal axis 34 of the vessel and/or the outlet, bottom 32 and/or downflow contactor of the vessel.

The method may include arranging bubble generator 58/58′/58″ seen in FIGS. 3 to 5 to function as a throttling device that sets a flow rate at which water is pumped into vessel 22 seen in FIG. 3. The method may include configuring the bubble generator to contain pump pressure head within the vessel. The method in this example includes increasing pressure within vessel 22 via bubble generator 58/58′/58″ seen in FIGS. 3 to 5. Referring back to FIG. 3, the method in this example includes configuring the bubble generator to create a backpressure that increases pressure within the vessel when water 54C, 55, 56A passes therethrough while continuing to process any free oxygen gas bubbles 60 into smaller bubbles, improving a dissolution rate of the free gas thereby.

The method may include dissipating pressure within vessel 22 via bubble generator 58/58′/58″ seen in FIGS. 3 to 5 in a manner that promotes breaking up of remaining undissolved gaseous bubbles and/or dissolving of bubbles passing through the vessel via the bubble generator. Referring back to FIG. 3, the method in this example thus includes configuring the bubble generator to further promote dissolving of oxygen 36 (shown injected into vessel 22 by arrow of numeral 35) within water 55 and 56A. The method in this example includes configuring bubble generator 58/58′/58″ seen in FIGS. 3 to 5 to reduce diameter D_{B} of oxygen gas bubbles 60 passing therethrough seen in FIG. 3.

Still referring to FIG. 3, the method includes outputting the water 56A/56B/56C of higher dissolved oxygen content. The method in this example includes forming upwelling 63 above vessel 22 to promote dispersal of the water of higher dissolved oxygen content. The method in this example includes positioning aeration system 62 above vessel 22 to promote dispersal of water 56A/56B/56C of higher dissolved oxygen content. The method may in this example include aligning the aeration system with the vessel to promote dispersal of the water of higher dissolved oxygen content. The method in this example includes positioning inlet 40 of pump 38 below aeration system 62 and the direction 66 of distribution of oxygen-enriched water. The method in this example includes injecting air 99/101 above vessel 22 to promote dispersal of water 56A/56B/56C of higher dissolved oxygen content. The method may in this example include forming aeration plume 87 above vessel 22 thereby. The method in this example includes dispersing water of elevated dissolved oxygen content throughout a larger volume of water 124 having a lower bulk dissolved oxygen concentration.

Many advantages result from the structure of the present invention. For example, oxygenation assembly 20 as herein described uses a single-diameter vessel 22 followed by bubble generator 58. The single-diameter vessel is selected with knowledge of the water throughput to specifically capture bubbles above a certain diameter. This mono-diameter design of vessel 22 may cause a loss of more small bubbles through the vessel than prior systems on the one hand. However, this may be compensated for by using bubble generator 58/58′/58″ seen in FIGS. 3 to 5 to process these small bubbles to even smaller sizes—dissolving them after the main reactor or vessel 22 seen in FIG. 3, but still effectively using the gas. This configuration and combination of components may enable oxygenation assembly 20 as herein described to be relatively smaller and lighter than prior known systems, while also being easier to handle.

Use of bubble generator 58/58′/58″ seen in FIGS. 3 to 5 after a downflow contactor may also function as an improvement over existing known systems. Typically contactors may be operated either unpressurized or lightly pressurized by means of a throttling valve situated downstream of the mass transfer vessel. Pressurizing vessel 22 as herein described may function to increase the rate of gas transfer, thereby enabling use of a smaller vessel and reaching higher attainable concentrations of dissolved oxygen within the water. Use of a throttling valve may dissipate the pumping energy while not assisting the mass transfer process with that dissipated energy. In contrast, oxygenation assembly 20 as herein described functions to pass the process flow through bubble generator 58/58′/58″ seen in FIGS. 3 to 5, which provides backpressure in a similar manner as a throttling valve, but while also continuing to process any free gas into even smaller bubbles, thereby improving their dissolution rate.

Bubble generator 58/58′/58″ as herein described may thus provide three main functions or mechanism for the oxygenation assembly. First, the bubble generator contains the pump pressure head within mass transfer vessel 22 seen in FIG. 3, ensuring that the pressure available from the pump input energy increases the mass transfer rate of the process. Second, bubble generator 58/58′/58″ seen in FIGS. 3 to 5 may act as a throttling device, functioning as the major restriction in oxygenation assembly 20 seen in FIG. 3 and setting the flowrate of pump 38. Third, the bubble generator may be configured to efficiently dissipate that same pressure in a manner that leads to the breakup of any remaining undissolved gaseous bubbles. These smaller bubbles may then be leveraged to enable more mass transfer in the pumped effluent water 56A/56B/56C. The combination of the fine bubbles and water upward velocity may create a finely dispersed flow regime in output conduit 88.

Oxygenation assembly 20 as herein described also integrates traditional aeration-upwelling equipment in line with a device or system for producing highly oxygenated water. Many prior known deployable systems for producing oxygenated water may be largely incompatible with upwelling, due to their relying on contact time during bubble rise to dissolve their gas species into the water. In an upwelling caused by a bubble plume, air bubbles and gas bubbles will mix, harming the efficacy of dissolution. Additionally, the rising water velocity lowers overall contact time before the bubble reaches the surface.

In contrast, oxygenation assembly 20 as herein described may result in and provide an outlet stream that features extremely little undissolved gas, with the majority of the gas already dissolved into the pumped water. The oxygenation assembly as herein described may thus effectively leverage an aeration-driven upwelling 63 to distribute high dissolved-oxygen water 56C over an area of low dissolved oxygen water 124.

Also, for oxygenation assembly 20 as herein described with its integrating of the use of aeration upwelling 63 with a device or system for producing highly oxygenated water, positioning of inlet 40 of pump 38 below diffuser 68 may ensure that little to no air is introduced into oxygen-water mass transfer vessel 22.

Oxygenation assembly 20 as herein described may comprise a submersible solution, with oxygen-water mass transfer vessel 22 and pump 38 configured to be selectively deployed as deeply as possible. Pump 38 and vessel 22 of the oxygenation assembly as herein described may be deployed as deeply as possible or desired, with the pumped effluent 56A/56B/56C and diffuser 68 being deployed at a desired depth for water mixing. Oxygenation assembly 20 as herein described may thus provide at least two main advantages over prior known systems. First, significant amounts of additional pressure over atmospheric pressure is available within mass transfer vessel 22 due to the hydrostatic head. This pressure is available freely, versus processes carried out at the surface that must expend energy via pumping to achieve the same levels of pressure. This may enable oxygenation assembly 20 as herein described to achieve much higher mass transfer rates and concentrations of dissolved oxygen for lower energy expenditure. The greater the depth to which vessel 22 is deployed, the higher may be the hydrostatic head within which the vessel operates. The pressure head inside the vessel may directly drive how space efficient the process may be, and the ultimate dissolved oxygen concentrations that may be reached.

Second, water 54A taking into pump 38 (or pump intake) may be colder than an at-surface intake solution without the use of a long intake pipe. Oxygenation assembly 20 as herein described may function to eliminate the need for a long intake pipe and may use the natural water thermocline in its favor to capture colder water. The latter may retain more gas than warmer water, thereby enabling the oxygenation assembly as herein described to achieve higher mass transfer rates and concentrations of dissolved oxygen within the water for lower energy expenditure. Deploying pump 38 in deep water may thus enable the pump to intake colder, untreated water.

Oxygenation assembly 20 as herein described, with its positioning of inlet 40 of pump 38 (or pump intake) inherently below the direction 66 of water distribution, may ensure that untreated water 54A/54B/54C is continually processed, and little to no recirculation of already processed water occurring. Recirculation is undesirable in an open-water treatment process as treating the same water continuously does little to affect the water body at large. For oxygenation assembly 20 with its layout as herein described, water is continually pulled up by the aeration upwelling 63, and inlet 40 of pump 38 may induce this water before any air is introduced to the stream.

Oxygenation assembly 20 as herein described, with its positioning of pump 38 at the bottom of the equipment chain, may provide the oxygenation assembly with and/or promote inherent stability. Oxygen-water mass transfer vessel 22 may be manufactured of a light plastic (though this is not strictly required) and diffuser 68 may be positively buoyant (though here too this is not strictly required). The overall center of buoyancy C_{B} may be approximately at the center of mass transfer vessel 22. As center of mass C_{M} of oxygenation assembly 20 as herein described may be concentrated closely to pump 38, the oxygenation assembly may be naturally self-righting when submerged.

It will be appreciated that many variations are possible within the scope of the invention described herein. Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
“where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

Examples of oxygenation assemblies, as well as methods of dissolving oxygen into water, have been described. The following clauses are offered as further description:
(1) An oxygenation assembly comprising: a mass transfer vessel configured to receive water and promote dissolving of oxygen therewithin; and a bubble generator downstream of the vessel, wherein the bubble generator is configured to increase pressure within the vessel when the water passes therethrough.
(2) An oxygenation assembly of any clause herein, wherein the bubble generator is configured to further promote dissolving of the oxygen within the water.
(3) An oxygenation assembly of any clause herein, wherein the bubble generator is configured to create a backpressure that increases said pressure within the vessel, with dissolving of the oxygen within the vessel being further promoted thereby.
(4) An oxygenation assembly of any clause herein, wherein the bubble generator is configured to promote formation of smaller bubbles from free gas within the water passing therethrough, improving a dissolution rate of said free gas thereby.
(5) An oxygenation assembly according to any clause herein, wherein the bubble generator is configured to create a backpressure which increases pressure within the vessel when the water passes therethrough while continuing to process any free gas into smaller bubbles, improving a dissolution rate of said free gas thereby.
(6) An oxygenation assembly according to any clause herein, wherein the bubble generator functions as a throttling device.
(7) An oxygenation assembly according to any clause herein, wherein the bubble generator is configured to reduce the diameter of bubbles passing therethrough.
(8) An oxygenation assembly according to any clause herein, wherein the bubble generator comprises an orifice sized to promote the creation of bubbles having diameters equal to or less than a predetermined threshold.
(9) An oxygenation assembly according to any clause herein, wherein a diameter of the vessel is selected based on a given water throughput to capture bubbles of oxygen above a threshold diameter.
(10) An oxygenation assembly according to any clause herein, wherein the vessel has a longitudinal axis and wherein the bubble generator aligns with said longitudinal axis.
(11) An oxygenation assembly according to any clause herein, wherein the bubble generator is adjacent an outlet of the vessel.
(12) An oxygenation assembly according to any clause herein, wherein the bubble generator is adjacent a bottom of the vessel.
(13) An oxygenation assembly according to any clause herein, wherein the bubble generator is adjacent a downflow contactor of the vessel.
(14) An oxygenation assembly of any clause herein, wherein the bubble generator comprises a venturi tube.
(15) An oxygenation assembly of any clause herein, wherein the bubble generator comprises an orifice generator.
(16) An oxygenation assembly of any clause herein, wherein the bubble generator comprises a swirl generator.
(17) An oxygenation assembly of any clause herein, wherein the bubble generator includes a rotor and one or more curved members coupled thereto and extending outwards therefrom, the rotor and said one or more curved members being shaped to promote breaking up of bubbles to a smaller sized bubbles having diameters equal to or less than a predetermined threshold.
(18) An oxygenation assembly according to any clause herein, including a pump configured to output said water to the vessel.
(19) An oxygenation assembly according to any clause herein, wherein the bubble generator functions as a throttling device which sets a flow rate of the pump.
(20) An oxygenation assembly according to any clause herein, wherein the bubble generator is configured to contain pump pressure head within the vessel.
(21) An oxygenation assembly according to any clause herein, wherein the bubble generator is configured to dissipate pressure within the vessel caused by the pump in a manner that promotes breaking up of remaining undissolved gaseous bubbles.
(22) An oxygenation assembly according to any clause herein, wherein the pump aligns with the longitudinal axis of the vessel.
(23) An oxygenation assembly according to any clause herein, wherein the pump is positioned below the vessel.
(24) An oxygenation assembly according to any clause herein, wherein the pump is positioned adjacent the outlet of the vessel.
(25) An oxygenation assembly according to any clause herein, wherein the pump is positioned adjacent the bottom of the vessel.
(26) An oxygenation assembly according to any clause herein, wherein the pump is configured to direct water of lower oxygen content into the vessel.
(27) An oxygenation assembly according to any clause herein, including an input conduit via which the vessel and the pump are in fluid communication.
(28) An oxygenation assembly according to any clause herein, wherein the input conduit extends adjacent at least in part to the vessel.
(29) An oxygenation assembly according to any clause herein, wherein the input conduit extends parallel with the vessel.
(30) An oxygenation assembly according to any clause herein, wherein the input conduit extends between and couples together the outlet of the pump with the inlet of the vessel.
(31) An oxygenation assembly according to any clause herein, including an aeration system.
(32) An oxygenation assembly according to any clause herein, wherein the aeration system is operatively coupled to the vessel.
(33) An oxygenation assembly according to any clause herein, wherein the aeration system is positioned above the vessel.
(34) An oxygenation assembly according to any clause herein, wherein the pump is positioned below the aeration system.
(35) An oxygenation assembly according to any clause herein, wherein the aeration system aligns with the longitudinal axis of the vessel.
(36) An oxygenation assembly according to any clause herein, wherein the aeration system is in line with the vessel.
(37) An oxygenation assembly according to any clause herein, wherein the aeration system is configured to selectively create an upwelling.
(38) An oxygenation assembly according to any clause herein, wherein the aeration system is configured to create a bubble plume.
(39) An oxygenation assembly according to any clause herein, wherein the oxygenation assembly is configured to output water with elevated levels of dissolved oxygen from the vessel towards the aeration system.
(40) An oxygenation assembly according to any clause herein, wherein pressurized or compressed gas or air is injected into the aeration system.
(41) An oxygenation assembly according to any clause herein, including an output conduit via which the vessel and the aeration system are in fluid communication.
(42) An oxygenation assembly according to any clause herein, wherein the aeration system is configured to direct upwards water of an elevated dissolved oxygen content outputted from the vessel.
(43) An oxygenation assembly according to any clause herein, wherein the output conduit is adjacent in part and/or extends parallel to the vessel.
(44) An oxygenation assembly according to any clause herein, wherein the output conduit is adjacent at least in part to the vessel.
(45) An oxygenation assembly according to any clause herein, wherein the output conduit extends parallel to the vessel.
(46) An oxygenation assembly according to any clause herein, wherein the output conduit extends from the outlet of the vessel and towards the aeration system.
(47) An oxygenation assembly according to any clause herein, wherein the output conduit extends upwards from the aeration system.
(48) An oxygenation assembly according to any clause herein, wherein the aeration system includes a diffuser via which air bubbles are diffused.
(49) An oxygenation assembly according to any clause herein, wherein the diffuser operatively couples to the vessel.
(50) An oxygenation assembly according to any clause herein, wherein the diffuser is annular and/or coil-shaped.
(51) An oxygenation assembly according to any clause herein, wherein the diffuser comprises a conduit that is annular at least in part, with the conduit having a plurality of circumferentially spaced-apart apertures extending therein.
(52) An oxygenation assembly according to any clause herein, wherein the diffuser extends about an axis parallel to the longitudinal axis of the vessel.
(53) An oxygenation assembly according to any clause herein, wherein the axis about which the diffuser extends is coaxial with the longitudinal axis of the vessel.
(54) An oxygenation assembly according to any clause herein, wherein the output conduit has a distal end aligned with or spaced-apart upwards from the diffuser.
(55) An oxygenation assembly according to any clause herein, wherein the output conduit being centrally positioned relative to the diffuser.
(56) An oxygenation assembly according to any clause herein, wherein the vessel is configured to be fully submersible.
(57) An oxygenation assembly according to any clause herein, wherein the vessel is configured to be pressurized.
(58) An oxygenation assembly according to any clause herein, wherein the vessel is a pressure vessel submersible within a body of water and wherein the vessel is configured to use at least in part pressure from the body of water to promote dissolving of oxygen within the mass transfer vessel.
(59) An oxygenation assembly according to any clause herein, wherein the oxygen is injected into the vessel.
(60) An oxygenation assembly according to any clause herein, wherein the vessel is an oxygen-water mass transfer vessel configured to receive said oxygen injected therein and said water therethrough.
(61) An oxygenation assembly according to any clause herein, wherein the oxygenation assembly is configured to be portable.
(62) An oxygenation assembly according to any clause herein, wherein the oxygenation assembly is one or more of selectively deployable or retrievable.
(63) An oxygenation assembly according to any clause herein, wherein the vessel is configured to receive water having a first concentration of dissolved oxygen and output water having a second concentration of dissolved oxygen that is greater than that of the first concentration of dissolved oxygen.
(64) An oxygenation assembly according to any clause herein, wherein the oxygenation assembly has a center of buoyancy which aligns with a center of mass of the vessel.
(65) An oxygenation assembly according to any clause herein, wherein the center of buoyancy of the oxygenation assembly generally corresponds to the center of mass of the vessel.
(66) An oxygenation assembly according to any clause herein, wherein the center of buoyancy of the oxygenation assembly is positioned above the center of mass of the vessel.
(67) An oxygenation assembly according to any clause herein, including a float member to which the vessel is coupled and below which the vessel is extendable.
(68) An oxygenation assembly of any clause herein, including a temperature sensor or gauge via which a target depth at or below which to submerge the vessel is determined.
(69) An oxygenation assembly of any clause herein, wherein the temperature sensor or gauge operatively couples to and/or is positioned near or adjacent the mass transfer vessel.
(70) An oxygenation assembly of any clause herein, including a pressure sensor or gauge via which the target depth at or below which to submerge the vessel is determined.
(71) An oxygenation assembly of any clause herein, wherein the pressure sensor or gauge operatively couples to and/or is positioned near or adjacent the mass transfer vessel.
(72) An oxygenation assembly of any clause herein, including a depth sensor or gauge via which the target depth at or below which to submerge the vessel is determined.
(73) An oxygenation assembly of any clause herein, wherein the depth sensor or gauge operatively couples to and/or is positioned near or adjacent the mass transfer vessel.
(74) An oxygenation assembly of any clause herein, including a processor which receives a signal from one or more said sensors or gauges and determines the extent to which the vessel should be lowered into the body of water based on the same.
(75) An oxygenation assembly of any clause herein, including an actuator configured to selectively adjust the vertical extent to which the mass transfer vessel is positioned within the body of water.
(76) An oxygenation assembly of any clause herein, wherein the processor is configured to receive signals from one or more of the sensors and selectively adjust vertical positioning of the mass transfer vessel within the body of water via the actuator.
(77) An oxygenation assembly of any clause herein, wherein the processor is configured to cause the mass transfer vessel to be lowered until the processor determines via the pressure sensor that the pressure of the body of water and/or the pressure adjacent the exterior of the mass transfer vessel is equal to or less than a predetermined pressure threshold.
(78) An oxygenation assembly of any clause herein, wherein the processor is configured to cause the mass transfer vessel to be lowered until the processor determines via the temperature sensor that the temperature of the body of water and/or the temperature adjacent the exterior of the mass transfer vessel is equal to or less than a predetermined temperature threshold.
(79) An oxygenation assembly of any clause herein, wherein the processor is configured to determine via the temperature sensor a thermocline of the body of water and cause the vessel to be positioned at or below said thermocline.
(80) An oxygenation assembly comprising: a mass transfer vessel configured to receive water and promote dissolving of oxygen therewithin; and a bubble generator downstream of the mass transfer vessel, wherein the vessel has a longitudinal axis and wherein the bubble generator aligns with said longitudinal axis.
(81) An oxygenation assembly comprising: a mass transfer vessel configured to receive water and promote dissolving of oxygen therewithin; and a bubble generator downstream of the mass transfer vessel, wherein the bubble generator comprises a throttling device.
(82) An oxygenation assembly comprising: a mass transfer vessel configured to receive water and promote dissolving of oxygen therewithin; and a bubble generator downstream of the mass transfer vessel, wherein the bubble generator comprises a venturi tube.
(83) An oxygenation assembly comprising: a mass transfer vessel configured to receive water and promote dissolving of oxygen therewithin; and a bubble generator downstream of the mass transfer vessel, wherein the bubble generator comprises an orifice generator.
(84) An oxygenation assembly comprising: a mass transfer vessel configured to receive water and promote dissolving of oxygen therewithin; and a bubble generator downstream of the mass transfer vessel, wherein the bubble generator comprises a swirl generator.
(85) An oxygenation assembly comprising: a submersible, pressurized mass transfer vessel to which water is pumped and oxygen injected; and a system for creating an upwelling using compressed or pressurized gas, the system coupling to the mass transfer vessel.
(86) An oxygenation assembly comprising: an oxygen-water mass transfer vessel; a pump in fluid communication with an inlet of the oxygen-water mass transfer vessel; a system for creating an upwelling using compressed or pressurized gas, the system being in fluid communication with an outlet of the oxygen-water mass transfer vessel; and a temperature sensor or gauge via which a target depth at or below which to submerge the vessel is determined.
(87) An oxygenation assembly comprising: an oxygen-water mass transfer vessel; a pump in fluid communication with an inlet of the oxygen-water mass transfer vessel; a system for creating an upwelling using compressed or pressurized gas, the system being in fluid communication with an outlet of the oxygen-water mass transfer vessel; and a pressure sensor or gauge via which a target depth at or below which to submerge the vessel is determined.
(88) An oxygenation assembly comprising: an oxygen-water mass transfer vessel; a pump in fluid communication with an inlet of the oxygen-water mass transfer vessel; a system for creating an upwelling using compressed or pressurized gas, the system being in fluid communication with an outlet of the oxygen-water mass transfer vessel; and a depth sensor or gauge via which the target depth at or below which to submerge the vessel is determined.
(89) An oxygenation assembly comprising: a mass transfer vessel configured to receive water and promote dissolving of oxygen therewithin; a bubble generator downstream of the mass transfer vessel; and a temperature sensor or gauge via which a target depth at or below which to submerge the vessel is determined.
(90) An oxygenation assembly comprising: a mass transfer vessel configured to receive water and promote dissolving of oxygen therewithin; a bubble generator downstream of the mass transfer vessel; and a pressure sensor or gauge via which a target depth at or below which to submerge the vessel is determined.
(91) An oxygenation assembly comprising: a mass transfer vessel configured to receive water and promote dissolving of oxygen therewithin; a bubble generator downstream of the mass transfer vessel; and a depth sensor or gauge via which the target depth at or below which to submerge the vessel is determined.
(92) An oxygenation assembly comprising: an oxygen-water mass transfer vessel; a pump in fluid communication with an inlet of the oxygen-water mass transfer vessel; and a system for creating an upwelling using compressed or pressurized gas, the system being in fluid communication with an outlet of the oxygen-water mass transfer vessel.
(93) An oxygenation assembly comprising: an oxygen-water mass transfer vessel; a pump; a first conduit which couples an output of the pump to an inlet of the vessel; and a second conduit having a proximal end operatively connected to an outlet of the vessel and a distal end spaced-apart upwards from the inlet of the vessel, wherein the conduits extend at least in part substantially parallel to the longitudinal axis of the vessel.
(94) An oxygenation assembly according to any clause herein, including a bubble generator in fluid communication with the outlet of the vessel.
(95) An oxygenation assembly according to any clause herein, wherein the mass transfer vessel is configured to receive the water therethrough in a downward direction and wherein the mass transfer vessel is configured to receive gaseous oxygen below a water inlet thereof.
(96) An oxygenation assembly according to any clause herein, wherein the mass transfer vessel is configured to receive gaseous oxygen between the water inlet and a water outlet thereof.
(97) An oxygenation assembly according to any clause herein, wherein the mass transfer vessel is configured to receive gaseous oxygen in a direction tangential to said downward direction.
(98) An oxygenation assembly according to any clause herein, wherein the mass transfer vessel is tubular.
(99) An oxygenation assembly according to any clause herein, wherein the mass transfer vessel is configured to be vertically extending at least in part in use.
(100) An oxygenation assembly according to any clause herein, wherein the mass transfer vessel comprises a conduit with said water inlet thereof at the top thereof, said water outlet thereof at the bottom thereof, and an oxygen inlet positioned between the top and the bottom thereof.
(101) An oxygenation assembly for aquaculture, the oxygenation assembly comprising: a mass transfer vessel configured to be submerged, receive water when so submerged and promote dissolving of oxygen therewithin when so submerged, the vessel having an inlet, an outlet spaced-apart from the inlet thereof, and a cross-sectional area that extends between the inlet and the outlet thereof, with the cross-sectional area of the vessel being substantially constant.
(102) An oxygenation assembly for aquaculture, the oxygenation assembly comprising: a mass transfer vessel configured to be fully submerged, receive water when so submerged and promote dissolving of oxygen therewithin when so submerged, wherein the oxygen is injected into the vessel, and wherein the vessel has an inlet, an outlet spaced-apart from the inlet thereof, and a cross-sectional area that extends between the inlet and the outlet thereof, with the cross-sectional area of the vessel being substantially constant; and a pump configured to output said water to the vessel, wherein the pump is positioned below the vessel, and wherein a diameter of the vessel is selected based on a given water throughput to capture bubbles of oxygen above a threshold diameter.
(103) An oxygenation assembly according to any clause herein, wherein the diameter of the vessel is selected based on the given water throughput to capture or absorb bubbles of oxygen for a given said threshold diameter or within a predetermined bubble diameter range.
(104) An oxygenation assembly according to any clause herein, including a bubble generator downstream of the vessel.
(105) An oxygenation assembly according to any clause herein, wherein the vessel is configured to promote a swarm of circulating oxygen bubbles entrained in a relatively slow downward flow of water.
(106) An oxygenation assembly according to any clause herein, wherein a majority of the injected said oxygen is entrained within the vessel in larger-bubble form and becomes a part of a mass transfer zone until the oxygen is dissolved within the water.
(107) An oxygenation assembly according to any clause herein, wherein a relatively small amount of the injected said oxygen is broken into fine bubbles which are carried with the water in the downward flow thereof.
(108) An oxygenation assembly for aquaculture, the oxygenation assembly comprising: a mass transfer vessel including an inlet and outlet via which water is pumpable therethrough and including a port between the inlet and outlet thereof and via which gaseous oxygen is injectable for dissolving in the water; a bubble generator downstream of the mass transfer vessel; and an aeration system coupled to and positioned above the mass transfer vessel.
(109) An oxygenation assembly for aquaculture, the oxygenation assembly comprising: a mass transfer vessel including an inlet and outlet via which water is pumpable therethrough and including a port between the inlet and outlet thereof and via which gaseous oxygen is injectable, the mass transfer vessel being fully submergible into a body of water so as to pressurize said water therewithin, with the mass transfer vessel using at least in part pressure from the body of water to promote dissolving of the gaseous oxygen into said water.
(110) Use of an oxygenation assembly according to any clause herein for aquaculture.
(111) A method of dissolving oxygen into water, the method comprising: submerging a mass transfer vessel into a body of water so as to pressurize water therewithin; injecting oxygen into the pressurized said mass transfer vessel; and outputting said water of higher dissolved oxygen content.
(112) A method according to any clause herein, including using at least in part pressure from the body of water to promote dissolving of oxygen within the mass transfer vessel.
(113) A method according to any clause herein, including injecting said oxygen into the vessel so pressurized, with dissolving of said oxygen into the water being promoted thereby.
(114) A method according to any clause herein, including using water at depth to promote dissolving of the oxygen therewithin.
(115) A method according to any clause herein, including using colder water from said body of water to promote dissolving of the oxygen therewithin.
(116) A method according to any clause herein, including submerging the mass transfer vessel below a thermocline of the body of water.
(117) A method according to any clause herein, including submerging the mass transfer vessel within the body of water until a temperature of the body of water equals to or less than a predetermined temperature threshold.
(118) A method according to any clause herein, including submerging the mass transfer vessel within the body of water to a depth at which said body of water has a temperature equal to or less than a predetermined temperature threshold.
(119) A method according to any clause herein, including submerging the mass transfer vessel within the body of water to or below a depth at which a pressure of said body of water is equal to or less than a predetermined pressure threshold.
(120) A method according to any clause herein, including forming an upwelling above the vessel to promote dispersal of the water of higher dissolved oxygen content.
(121) A method according to any clause herein, including injecting pressurized or compressed gas above the vessel to promote dispersal of the water of higher dissolved oxygen content.
(122) A method according to any clause herein, including injecting air above the vessel to promote dispersal of the water of higher dissolved oxygen content.
(123) A method according to any clause herein, including forming an aeration plume above the vessel.
(124) A method according to any clause herein, including positioning an aeration system above the vessel to promote dispersal of the water of higher dissolved oxygen content.
(125) A method according to any clause herein, including aligning the aeration system with the vessel to promote dispersal of the water of higher dissolved oxygen content.
(126) A method according to any clause herein, including pumping water from below the vessel therewithin.
(127) A method according to any clause herein, including providing a pump to direct water through the vessel.
(128) A method according to any clause herein, including positioning an inlet of the pump below the vessel.
(129) A method according to any clause herein, including positioning the inlet of the pump below a direction of distribution of oxygen-enriched water.
(130) A method according to any clause herein, including pumping water from below the aeration system into the vessel.
(131) A method according to any clause herein, including dispersing water of elevated dissolved oxygen content throughout a larger volume of water having a lower bulk dissolved oxygen concentration.
(132) A method according to any clause herein, including positioning of a bubble generator downstream of the vessel.
(133) A method according to any clause herein, including positioning the bubble generator in fluid communication with the outlet of the vessel.
(134) A method according to any clause herein, including promoting dissolving of bubbles passing through the vessel via the bubble generator.
(135) A method according to any clause herein, including configuring the bubble generator to reduce the diameter of bubbles passing therethrough.
(136) A method according to any clause herein, including configuring the bubble generator to further promote dissolving of the oxygen within the water.
(137) A method according to any clause herein, including configuring the bubble generator to create a backpressure which increases pressure within the vessel when the water passes therethrough while continuing to process any free gas into smaller bubbles, improving a dissolution rate of said free gas thereby.
(138) A method according to any clause herein, including increasing pressure within the vessel via the bubble generator.
(139) A method according to any clause herein, including aligning the bubble generator with a longitudinal axis of the vessel.
(140) A method according to any clause herein, including positioning the bubble generator adjacent an outlet and/or a bottom of the vessel.
(141) A method according to any clause herein, including positioning the bubble generator adjacent a downflow contactor of the vessel.
(142) A method according to any clause herein, including arranging the bubble generator to function as a throttling device.
(143) A method according to any clause herein, including configuring the bubble generator to function as a throttling device which sets a flow rate at which water is pumped into the vessel.
(144) A method according to any clause herein, including configuring the bubble generator to contain the pump pressure head within the vessel.
(145) A method according to any clause herein, including dissipating pressure within the vessel via the bubble generator in a manner that promotes breaking up of remaining undissolved gaseous bubble.
(146) A method of oxygenating water for aquaculture, the method comprising: generating within a body of water a pumped stream water of high dissolved oxygen as a point-source; and directing said pumped stream of water of high dissolved oxygen into an aeration bubble plume for dispersal.
(147) A method of oxygenating water for aquaculture, the method comprising submerging an oxygenation assembly into a body of water; pumping water through the oxygenation assembly so submerged and dissolving gaseous oxygen at depth into said water so pumped so as to raise the dissolved oxygen (DO) concentration of the water; and dispersing the water so oxygenated throughout a larger water volume with a lower bulk DO concentration.
(148) A method according to any clause herein, including dispersing the water so oxygenated via an aeration bubble plume.
(149) Apparatus comprising any new useful and inventive feature, combination of features or sub-combination of features described or clearly inferred herein.
(150) A method comprising any new, useful and inventive step, act, combination of steps and/or acts, or sub-combination of steps and/or acts described or clearly inferred herein.
It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. An oxygenation assembly for aquaculture, the oxygenation assembly comprising:
a mass transfer vessel configured to be fully submerged, receive water when so submerged and promote dissolving of oxygen therewithin when so submerged, wherein the oxygen is injected into the mass transfer vessel, and wherein the mass transfer vessel has an inlet, an outlet spaced-apart from the inlet thereof, and a cross-sectional area that extends between the inlet and the outlet thereof, with the cross-sectional area of the mass transfer vessel being substantially constant; and
a pump via which said water is outputted to the mass transfer vessel, wherein the pump is positioned below the mass transfer vessel, and wherein a diameter of the mass transfer vessel is selected based on a given water throughput to capture bubbles of oxygen above a threshold diameter.

2. An oxygenation assembly according to claim 1, wherein the diameter of the mass transfer vessel is selected based on the given water throughput to capture or absorb bubbles of oxygen for a given said threshold diameter or within a predetermined bubble diameter range.

3. An oxygenation assembly according to claim 1, wherein the mass transfer vessel is a pressure vessel submersible within a body of water and wherein the mass transfer vessel is configured to use at least in part pressure from the body of water to promote dissolving of oxygen within the mass transfer vessel.

4. An oxygenation assembly according to claim 1, wherein the mass transfer vessel is configured to receive the water therethrough in a downward direction, wherein the mass transfer vessel is configured to receive gaseous said oxygen below a water said inlet thereof in a direction tangential to said downward direction.

5. An oxygenation assembly according to claim 1, wherein the mass transfer vessel is configured to promote a swarm of circulating oxygen bubbles entrained in a relatively slow downward flow of water, with a majority of the injected said oxygen being entrained within the mass transfer vessel in larger-bubble form and becoming a part of a mass transfer zone until the oxygen is dissolved within the water, and with a relatively small amount of the injected said oxygen being broken into fine bubbles which are carried with the water in the downward flow thereof.

6. An oxygenation assembly according to claim 1, wherein the pump aligns with the longitudinal axis of the mass transfer vessel, wherein the mass transfer vessel is configured to be vertically extending at least in part in use, wherein the oxygenation assembly has a center of buoyancy (C_{B}) which aligns with a center of mass (C_{M}) of the mass transfer vessel, and wherein the center of buoyancy of the oxygenation assembly is positioned above the center of mass of the mass transfer vessel.

7. An oxygenation assembly according to claim 1, including a float member coupled to and positioned above the mass transfer vessel.

8. An oxygenation assembly according to claim 1, including a temperature sensor or gauge via which a target depth at or below which to submerge the mass transfer vessel is determined, a pressure sensor or gauge via which the target depth at or below which to submerge the mass transfer vessel is determined and/or a depth sensor or gauge via which the target depth at or below which to submerge the mass transfer vessel is determined.

9. An oxygenation assembly for aquaculture, the oxygenation assembly comprising:
a mass transfer vessel including an inlet and outlet via which water is pumpable therethrough and including a port between the inlet and outlet thereof and via which gaseous oxygen is injectable, the mass transfer vessel being fully submergible into a body of water so as to pressurize said water therewithin, with the mass transfer vessel using at least in part pressure from the body of water to promote dissolving of the gaseous oxygen into said water.

10. An oxygenation assembly according to claim 9, including a bubble generator downstream of the mass transfer vessel, the bubble generator promoting formation of smaller bubbles from free gas within the water passing therethrough, improving a dissolution rate of said free gas thereby.

11. An oxygenation assembly according to claim 9, including a bubble generator downstream of the mass transfer vessel, with the bubble generator creating a backpressure that increases the pressure within the mass transfer vessel, with dissolving of the gaseous oxygen within the mass transfer vessel being further promoted thereby.

12. An oxygenation assembly according to claim 9, including a pump via which the water is pumpable through the mass transfer vessel and including a bubble generator downstream of the mass transfer vessel, with the bubble generator functioning as a throttling device which sets a flow rate of the pump.

13. An oxygenation assembly according to claim 9, including a bubble generator via which pressure within the mass transfer vessel is dissipated in a manner that promotes breaking up of remaining undissolved gaseous bubbles.

14. An oxygenation assembly according to claim 9, including a bubble generator downstream of the mass transfer vessel, with the bubble generator comprising one or more of: a venturi tube; an orifice generator; a swirl generator; or a rotor and one or more curved members coupled thereto and extending outwards therefrom, with the rotor and said one or more curved members being shaped to promote breaking up of bubbles to a smaller sized bubbles having diameters equal to or less than a predetermined threshold.

15. A method of oxygenating water for aquaculture using the oxygenation assembly of claim 9, the method comprising:
submerging the mass transfer vessel into the body of water so as to pressurize the water therewithin;
injecting oxygen into the pressurized said mass transfer vessel;
using at least in part pressure from the body of water to promote dissolving of said oxygen within the mass transfer vessel; and
outputting said water of higher dissolved oxygen content.

16. A method of oxygenating water for aquaculture using the oxygenation assembly of claim 9, the method comprising:
generating within the body of water a pumped stream water of higher dissolved oxygen as a point-source; and
directing said pumped stream of water of higher dissolved oxygen into an aeration bubble plume for dispersal.

17. An oxygenation assembly for aquaculture, the oxygenation assembly comprising:
a mass transfer vessel including an inlet and outlet via which water is pumpable therethrough and including a port between the inlet and outlet thereof and via which gaseous oxygen is injectable for dissolving in the water;
a bubble generator downstream of the mass transfer vessel; and
an aeration system coupled to and positioned above the mass transfer vessel.

18. An oxygenation assembly according to claim 17, wherein the aeration system and/or bubble generator substantially align longitudinally with the mass transfer vessel.

19. An oxygenation assembly according to claim 17, wherein the mass transfer vessel outputs water of higher dissolved oxygen and wherein the aeration system creates an upwelling via which the water of higher dissolved oxygen is dispersed upwards.

20. An oxygenation assembly according to claim 17, including an output conduit via which the mass transfer vessel and the aeration system are in fluid communication, with the output conduit having a distal end aligned with or spaced-apart upwards from the aeration system.
